(19) United States
(12) Patent Application Publication
(10) Pub. No.: US 2019/0370203 A1
(43) Pub. Date: Dec. 5, 2019

(54) Switch Board for Expanding Peripheral Component Interconnect Express Compatibility

(71) Applicant: Wiwynn Corporation, New Taipei City (TW)

(72) Inventors: Chia-Nung Tseng, New Taipei City (TW); Ming-Feng Hsieh, New Taipei City (TW); Yuan-Zhih Tsai, New Taipei City (TW)

(21) Appl. No.: 16/257,033

(22) Filed: Jan. 24, 2019

(30) Foreign Application Priority Data
Jun. 1, 2018 (TW) 107118979

(51) Int. Cl. G06F 13/40; G06F 13/36; G06F 13/38

(52) U.S. Cl. CPC G06F 13/4022; G06F 2213/0026; G06F 13/385; G06F 13/36

(57) ABSTRACT

A switch board for expanding PCIe compatibility comprises at least two PCIe slots with a first channel number, and a PCIe card with a second channel number, which is connected with the two PCIe slots via a channel conversion module, whereby the PCIe card simultaneously receives the bus signal transmitted from a processor of the switch board from the two PCIe slots. The present invention proposes a circuit board with flexible PCIe configuration, for further realizing optimized combination performance, and saving costs

### BACKGROUND OF THE INVENTION

### 1. Field of the Invention

The present invention relates to a circuit supporting multiple types of PCIe interface, and more particularly, to a circuit for expanding PCIe compatibility via power supply slot and PCB trace.

### 2. Description of the Prior Art

Peripheral component interconnect express (PCIe) technology for high-speed and high-efficiency transmission is becoming more and more important in industrial field. In recent years, the progress of AI and machine learning result in more data and computing requirements, so PCIe technology with higher transmission rate and channel bandwidth is necessary. For example, PCIe can increase the bandwidth by increasing the number of channels, such as interface of x1, x2, x4, x8, x16, and x32. With 16 channels, namely PCIe x16 interface, it has a 4 GB/s bandwidth for simplex operation. In addition, PCIe can be operated in full-duplex mode, that is, the transmitting and receiving ends can perform transmission/reception in both directions. Therefore, in the full-duplex specification, the transmission bandwidth of PCIe x16 interface can reach 8 GB/s.

In order to meet diverse configuration trends of industrial PCs and requirements for serial connection with high-speed devices, how to flexibly allocate different PCIe interfaces for computers or servers in a limited space becomes an important topic to the manufacturers. Conventional computer or server manufacturers need to deploy slots for a variety of I/O buses on the motherboard, but generally there is not enough space for installing all slots for the I/O buses, so the number of slots for the I/O buses is strictly limited. In order to meet various needs of users, it is necessary to develop a motherboard with several combinations of I/O buses. For example, in the existing hardware layout, there is no PCIe x32 interface, and the conventional motherboard is limited to a fixed hardware configuration, so the graphics processing unit (GPU), namely a PCIe card, does not have a corresponding PCIe interface. Thus, in order to maximize the performance of the GPU, the hardware designer must replace the motherboard with the corresponding PCIe interface to match to the GPU, but this method requires purchase or production of different motherboards, which increases cost to achieve high-performance.

As a result, the conventional PCIe interface configuration on the motherboard lacks flexibility, which is obviously not practical and economical.

### SUMMARY OF THE INVENTION

It is therefore an objective to provide a switch board for expanding PCIe compatibility to solve the above problem.

The present invention discloses a switch board for expanding peripheral component interconnect express, PCIe, compatibility. The switch board comprises at least two PCIe slots with a first number of channels, and a PCIe card with a second number of channels, which is connected with the two PCIe slots via a channel conversion module, whereby the PCIe card simultaneously receives a bus signal transmitted from a processor of the switch board from the two PCIe slots.

The present invention discloses a switch board for expanding peripheral component interconnect express, PCIe, compatibility. The switch board comprises at least a power supply slot, for providing power to an expanding wild card, and a PCIe card with a first number of channels, which is placed in the power supply slot and connected to a processor of the switch board by two signal lines with a second number of channel, for receiving a bus signal from the processor by the two signal lines.

The present invention discloses a switch board for expanding peripheral component interconnect express, PCIe, compatibility. The switch board comprises a PCIe slot with a first number of channels, and a PCIe card with a second number of channels, which is placed in the PCIe slot, and connected to a processor of the switch board by a signal line with the first number of channels, for receiving a bus signal from the processor by the signal line and the PCIe slot.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 are schematic diagrams of PCIe interface configuration according to the present disclosure.

### DETAILED DESCRIPTION

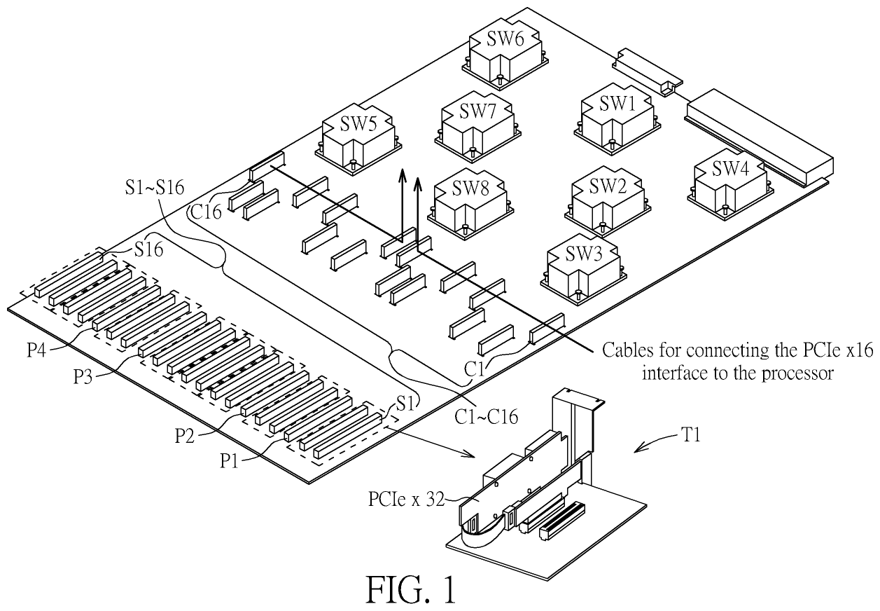

FIG. 1 is a schematic diagram of a peripheral component interconnect express (PCIe) interface configuration according to the present disclosure. The present disclosure provides a switch board to support a plurality of PCIe interfaces, such as PCIe x8 interface, PCIe x16 interface, and PCIe x32 interface, so as to obtain the best combination with a graphics processing unit, GPU, (hereafter called a PCIe card) and enhance the performance. In FIG. 1, the switchboard is configured with four power supply slots P1-P4, sixteen PCIe slots S1-S16, sixteen PCIe connectors C1-C16, and eight PCIe switches SW1-SW8. Note that, FIG. 1 is simply utilized for illustrating the structure of the switch board, wherein the number of components is not limited herein. The power supply slots P1-P4 are used for providing power to an interface card, such as a wild card or PCIe card, for operation. The PCIe slots S1-S16 are placed with the PCIe cards, and transmit a bus signal from a processor (not shown in FIG. 1) to the PCIe cards with printed signal lines of the switch board. The PCIe connectors C1-C16 are connected to the processor with the printed signal lines, and connected to the PCIe cards with internal cables, to transmit the bus signal form the processor to the PCIe cards. The PCIe switches SW1-SW8 are used for distributing PCIe channels, so as to expanding the bus signal from the processor to the PCIe cards. In this embodiment, PCIe slots and PCIe connectors of the switchboard are PCIe x16 interface. Since conventional switch board is limited by the PCB installation area and the deployment of the PCIe x32 interface is not yet widespread, the present invention proposes utilizing the channel conversion module T1 to connect two PCIe x16 interface slots (e.g. PCIe slots S1-S2), and thus the PCIe x32 interface card placed in the channel conversion module T1 can receive the bus signal with PCIe x16 interface from the processor with the two PCIe x16 interface slots, so as to increase the flexibility of PCIe interface configuration. The channel conversion module T1 of FIG. 1 is merely illustrative, and the number is not limited thereto. For example, the channel conversion module T1 is used to connect any two of the PCIe slots S1-S16, so that eight pairs of PCIe slots is formed for supporting eight PCIe x32 interface cards. In a word, the channel conversion module T1 is a conversion card for converting PCIe x16 interface to PCIe x32 interface.

In an embodiment, universal interface cards or PCIe x16 interface cards are placed in the power supply slots P1-P4, and connected to the PCIe connectors C1-C16 with the internal cables, such that the PCIe x16 interface card can receives the bus signal with PCIe x16 interface from the processor. In other words, the switch board of the present invention can support multiple PCIe interface configurations (such as PCIe x16 interface and PCIe x32 interface).

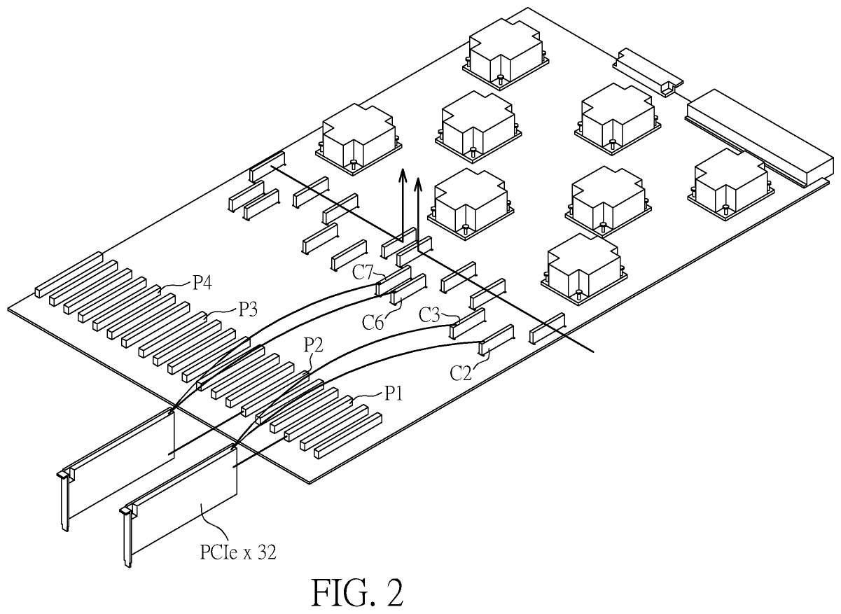

FIG. 2 is a schematic diagram of a PCIe interface configuration according to an embodiment. In this embodiment, the PCIe x32 interface card is placed in the power supply slots P1-P4, and each PCIe x32 interface card is connected to two PCIe connectors through two internal cables. Therefore, the PCIe x32 interface card can receive the bus signal with PCIe x16 interface from the processor through the two internal cables. In other words, by adding a power supply slot and an internal cable, the switch board is able to support the PCIe x32 interface. In addition, the original sixteen PCIe slots S1-S16 can still be placed with the PCIe x16 interface card, so that the compatibility of the switch board is enhanced.

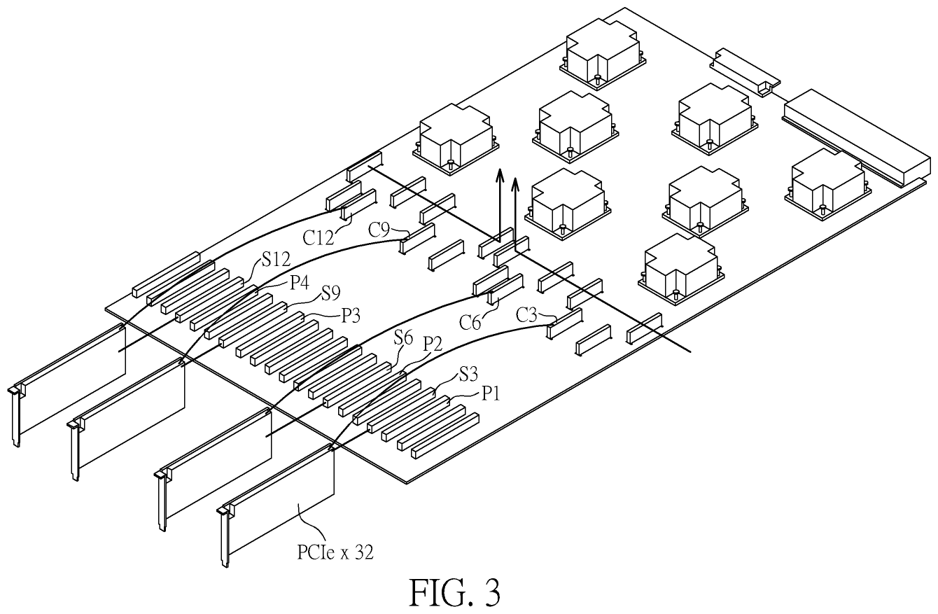

FIG. 3 is a schematic diagram of a PCIe configuration according to an embodiment. In this embodiment, the PCIe x32 interface card is placed in the PCIe x16 interface slot and connected to one PCIe connector by the internal cable. Therefore, the processor can transmit the bus signal with PCIe x16 interface to the PCIe x32 interface card through the PCIe x16 interface slot and the internal cable. In addition, the PCIe x16 interface slot that is not inserted the PCIe x32 interface card can still be used to place the PCIe x16 interface card. Therefore, the switch board of the embodiment can implement various PCIe interface configurations.

In conclusion, the present invention addresses to PCB architecture capable of flexibly configuring PCIe interfaces, without purchasing and replacing different motherboards, to solve the problem of limited number of PCIe slots on the conventional motherboard, or not proving two types of PCIe interface on the conventional motherboard. In detail, the switch board of the present invention supports different hardware configurations (i.e. multiple PCIe interface configurations) to optimize performance and saving cost by the internal cable, the power supply slot, and PCIe interface conversion card.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A switch board for expanding peripheral component interconnect express, PCIe, compatibility comprising:
at least two PCIe slots with a first number of channels; and
a PCIe card with a second number of channels, which is connected with the two PCIe slots via a channel conversion module, whereby the PCIe card simultaneously receives a bus signal transmitted from a processor of the switch board from the two PCIe slots.

2. The switch board of claim 1, wherein the channel conversion module is a conversion card for converting PCIe x16 interface to PCIe x32 interface.

3. The switch board of claim 1, further comprising:
a power supply slot, for providing power to an expanding wild card.

4. The switch board of claim 3, wherein the wild card is placed in the power supply slot and connected to the processor with a signal line for receiving the bus signal from the processor.

5. A switch board for expanding peripheral component interconnect express, PCIe, compatibility comprising:
at least a power supply slot, for providing power to an expanding wild card; and
a PCIe card with a first number of channels, which is placed in the power supply slot and connected to a processor of the switch board by two signal lines with a second number of channel, for receiving a bus signal from the processor by the two signal lines.

6. The switch board of claim 5, wherein the PCIe card with the first number of channels is PCIe x32 interface, and the signal line with the second number of channels is PCIe x16 interface.

7. A switch board for expanding peripheral component interconnect express, PCIe, compatibility comprising:
a PCIe slot with a first number of channels; and
a PCIe card with a second number of channels, which is placed in the PCIe slot, and connected to a processor of the switch board by a signal line with the first number of channels, for receiving a bus signal from the processor by the signal line and the PCIe slot.

8. The switch board of claim 7, further comprising:
a power supply slot, for providing power to an expanding wild card.

9. The switch board of claim 8, wherein the wild card is placed in the power supply slot and connected to the processor with a signal line for receiving the bus signal from the processor.
